(19) United States
(12) Patent Application Publication
(10) Pub. No.: US 2024/0010172 A1
(43) Pub. Date: Jan. 11, 2024

(54) VEHICULAR BODY LIQUID REMOVING DEVICE

(71) Applicant: Mohammed Faleeh, Anaheim, CA (US)

(72) Inventor: Mohammed Faleeh, Anaheim, CA (US)

(21) Appl. No.: 17/860,612

(22) Filed: Jul. 8, 2022

(51) Int. Cl. B60S 3/04

(52) U.S. Cl. CPC B60S 3/045

(57) ABSTRACT

A vehicular body liquid removing device for manually removing liquid from a vehicle body includes a base having a curvature. A top wall of the base has a peripheral surface and a hidden surface. The base is an injection molded rubber material being bendable thus the curvature of the base is able to flatten. A handle is attached to the peripheral surface of the base. A filling is positioned within an interior of the base. The filling is a metal material assisting in retaining the curvature of the base. The filling has a bottom surface where a wiper is attached to. The wiper is an extruded silicone rubber material being liquid impervious thus repelling a liquid from the wiper.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to vehicle liquid remover devices and more particularly pertains to a new vehicle liquid remover device for manually removing liquid from a vehicle body.

### (2) Description of Related Art Including Information Disclosed Under 37 CFR 1.97 and 1.98

The prior art relates to vehicle liquid remover devices. The prior art includes a variety of vehicle liquid remover devices configured for removing liquid and other debris from the body of a vehicle. Known prior art lacks a vehicle liquid removed device including a handle positioned on a first end of a base to remove liquid and other debris from a vehicle using a wiper having silicone rubber material.

### (h) BRIEF SUMMARY OF THE INVENTION

An embodiment of the disclosure meets the needs presented above by generally comprising a base. The base has a curvature. A top wall of the base has a peripheral surface and a hidden surface. Furthermore, the base has an interior. The base is an injection molded rubber material being configured for being bendable wherein the curvature of the base is able to flatten. A handle is coupled to the peripheral surface of the base. The handle the handle has a grip being configured for nesting the fingers of the user against. A filling is positioned within the interior of the base. The filling is a metal material being configured for assisting in retaining the curvature of the base. The filling has a bottom surface. A wiper is coupled to the bottom surface of the filling. The wiper is an extruded silicone rubber material being configured for being liquid impervious wherein repelling a liquid from the wiper.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a vehicular body liquid removing device according to an embodiment of the disclosure.

FIG. 2 is a cross-sectional view of an embodiment of the disclosure taken from FIG. 1 of Line 2-2.

FIG. 3 is a front view of an alternate embodiment of the disclosure.

FIG. 4 is a front view of an alternate embodiment of the disclosure.

FIG. 5 is an in-use view of an embodiment of the disclosure.

### (j) DETAILED DESCRIPTION OF THE INVENTION

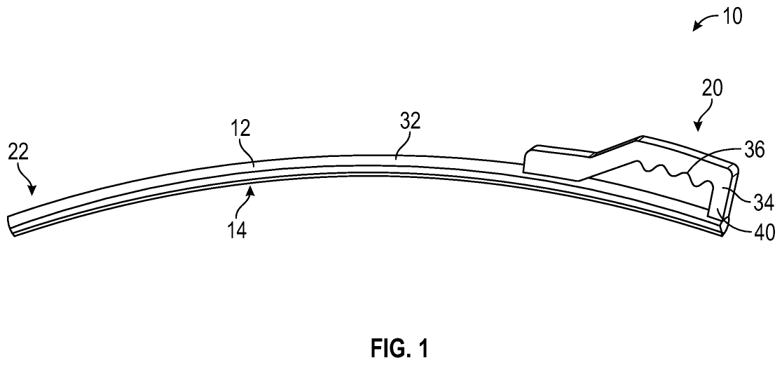

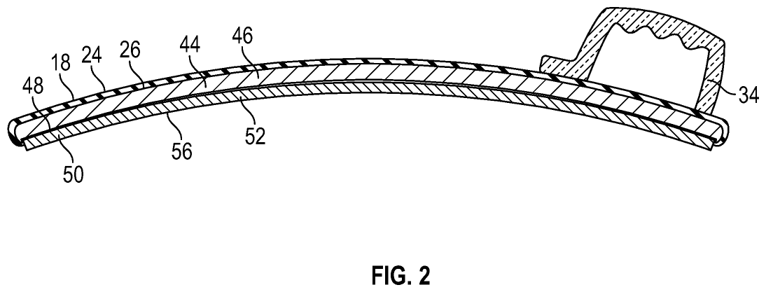

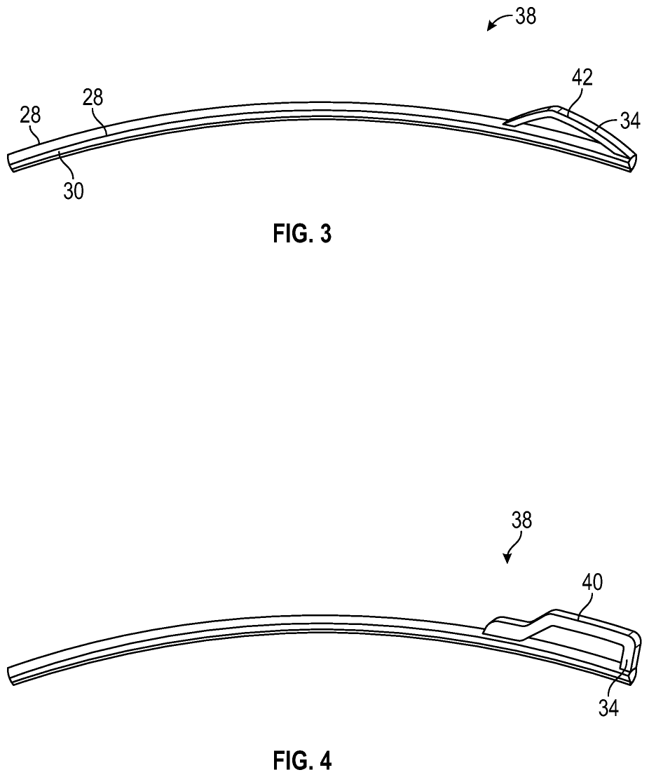

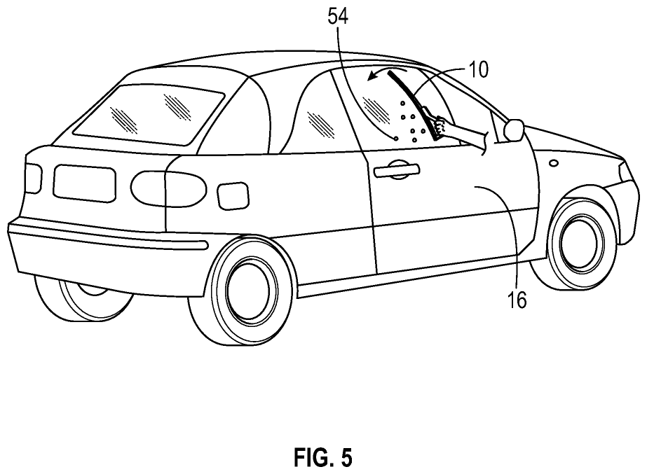

With reference now to the drawings, and in particular to FIGS. 1 through 5 thereof, a new vehicle liquid remover device embodying the principles and concepts of an embodiment of the disclosure and generally designated by the reference numeral 10 will be described.

As best illustrated in FIGS. 1 through 5, the vehicular body liquid removing device 10 generally comprises a base 12. The base 12 has a curvature 14 being configured for being complementary to an exterior shape of a vehicle 16. The curvature 14 is designed to abut the surface of the vehicle 16 as the base 12 slides along the vehicle 16. The base 12 has a top wall 18 including a first end 20 and a second end 22. The top wall has a peripheral surface 24 and a hidden surface 26. Additionally, the base 12 has a pair of edges 28. A pair of lateral walls 30 protrudes out from a respective one of the pair of edges 28 of the base 12. The base 12 has an interior defining a place for an element to be positioned within. The base 12 is an injection molded rubber material 32 being configured for being bendable wherein the curvature 14 of the base 12 is able to flatten against the vehicle 16 when pressure is applied to the base 12.

A handle 34 is coupled to the peripheral surface 24 of the base 12. The handle 34 has a rectangular shape 40 and includes a grip 36. The grip 36 is configured for nesting the fingers of the user against when in-use. The handle 34 is positioned on the first end 20 of the top wall 18 of the base 12. An alternate embodiment 38 of the vehicular body moisture removing device 10 lacks the grip 36 of the handle 34. Furthermore, the alternate embodiment 38 of the handle 34 lacks the rectangular shape 40. Rather, the alternate embodiment 38 of the handle 34 has a triangular shape 42.

A filling 44 is positioned within the interior of the base 12. The filling 44 is a metal material 46 being configured for assisting in retaining the curvature 14 of the base 12. The filling 44 has a bottom surface 48 being positioned outside of the interior of the base 12. A wiper 50 is coupled to the bottom surface 48 of the filling 44. The wiper 50 is positioned from the first end 20 to the second end 22 of the top wall 18 of the base 12. The wiper 50 is an extruded silicone rubber material 52 being configured for being liquid impervious wherein repelling a liquid 54 from the wiper 50. The wiper 50 has a tip 56 being configured for gliding against the vehicle 16 wherein removing the liquid 54 from the vehicle 16.

In use, the user grasps the handle 34 and glides the wiper 50 against the surface of the vehicle 16. The wiper 50 repels against the liquid 54, thus removing the liquid 54 as the wiper 50 swipes along the surface of the vehicle 16. The user can apply force upon the base 12 to flatten the curvature 14 of the wiper 50 against flat surfaces upon the vehicle 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicular body moisture removing device configured to wipe away liquid and other debris upon a vehicle's exterior, the vehicular body moisture removing device comprising:
a base having a curvature, the base having a top wall, the top wall having a first end and a second end, the top wall having a peripheral surface and a hidden surface, the base having an interior, the base being an injection molded rubber material, the injection molded rubber material being configured for being bendable wherein the curvature of the base is able to flatten;
a handle being coupled to the peripheral surface of the base, the handle having a grip extending between a first extension and a second extension, the first extension being coupled to the peripheral surface aligned with the first end of the top wall, the first extension being perpendicular to the grip, the second extension having a base portion and an angled portion, said base portion being parallel to the grip, the angled portion being angled relative to the grip and base portion wherein the angled portion extends outwardly from the grip and towards the peripheral surface, the grip being configured for nesting the fingers of the user against;
a filling being positioned within the interior of the base, the filling being a metal material, the metal material being configured for assisting in retaining the curvature of the base, the filling having a bottom surface;
a wiper being coupled to the bottom surface of the filling, the wiper being an extruded silicone rubber material, the extruded silicone rubber material being configured for being liquid impervious wherein repelling a liquid from the wiper.

2. The vehicular body moisture removing device of claim 1, further comprising the curvature being configured for being complementary to an exterior shape of a vehicle.

3. (canceled)

4. The vehicular body moisture removing device of claim 1, further comprising the base having a pair of edges, a pair of lateral walls protruding out from a respective one of the pair of edges of the base.

5. The vehicular body moisture removing device of claim 1, further comprising the interior of the base defining a place fir an element to be positioned within.

6. The vehicular body moisture removing device of claim 4, further comprising the handle having a rectangular shape.

7. The vehicular body moisture removing device of claim 6, further comprising the handle being positioned on the first end of the top wall of the base.

8. (canceled)

9. The vehicular body moisture removing device of claim 7, further comprising the bottom surface being positioned outside of the interior of the base.

10. The vehicular body moisture removing device of claim 9, further comprising the wiper being positioned from the first end to the second end of the top wall of the base.

11. The vehicular body moisture removing device of claim 10, further comprising the wiper having a tip, the tip of the wiper being configured for gliding against the vehicle wherein removing the liquid from the vehicle.

12. A vehicular body moisture removing device configured to wipe away liquid and other debris upon a vehicle's exterior, the vehicular body moisture removing device comprising:
a base having a curvature, the curvature being configured for being complementary to an exterior shape of a vehicle, the base having a top wall, the top wall having a first end and a second end, the top wall having a peripheral surface and a hidden surface, the base having a pair of edges, a pair of lateral walls protruding out from a respective one of the pair of edges of the base, the base having an interior, the interior defining a place for an element to be positioned within, the base being an injection molded rubber material, the injection molded rubber material being configured for being bendable wherein the curvature of the base being able to flatten;
a handle being coupled to the peripheral surface of the base, the handle having a rectangular shape, the handle having a grip, extending between a first extension and a second extension, the first extension being coupled to the peripheral surface aligned with the first end of the top wall of the base, the first extension being perpendicular to the grip, the second extension having a base portion and an angled portion, said base portion being parallel to the grip, the angled portion being angled relative to the grip and base portion wherein the angled portion extends outwardly from the grip and towards the peripheral surface, the grip being configured for nesting the fingers of the user against, the handle being positioned on the first end of the top wall of the base;
a filling being positioned within the interior of the base, the filling being a metal material, the metal material being configured for assisting in retaining the curvature of the base, the filling having a bottom surface, the bottom surface being positioned outside of the interior of the base; and
a wiper being coupled to the bottom surface of the filling, the wiper being positioned from the first end to the second end of the top wall of the base, the wiper being an extruded silicone rubber material, the extruded silicone rubber material being configured for being liquid impervious wherein repelling a liquid from the wiper, the wiper having a tip, the tip of the wiper being configured for gliding against the vehicle Wherein removing the liquid from the vehicle.
